(19) United States
(12) Patent Application Publication
(10) Pub. No.: US 2014/0272008 A1
(43) Pub. Date: Sep. 18, 2014

(54) METHODS FOR PROCESSING POULTRY THIGH MEAT

(71) Applicant: PERDUE FOODS LLC, Salisbury, DE (US)

(72) Inventor: George Wilson, Delmar, DE (US)

(21) Appl. No.: 13/838,799

(22) Filed: Mar. 15, 2013

(51) Int. Cl. A22C 21/00; A23L 1/315

(52) U.S. Cl. CPC A22C 21/0076; A23L 1/315; A23L 1/3157
USPC 426/92; 452/135; 452/125; 426/644

(57) ABSTRACT

Methods for preparing boneless thigh meat poultry products from poultry thighs comprise isolating a portion of thigh meat (a “premium thigh cut”) that cooks more evenly than the thigh generally and has an appealing texture. The methods provide boneless thigh products that have a low fat content, and are substantially free of undesirable components such as sinew and cartilage.

### FIELD OF THE INVENTION

The present invention relates generally to methods for processing poultry food products, and more particularly, to methods for processing poultry thigh meat.

### BACKGROUND OF THE INVENTION

In recent years, there has been an increasing demand for meat products which are boneless and therefore easier to prepare and consume. Poultry products, such as chicken and turkey, include “white meat” and “dark meat,” with white meat generally located in the breast and dark meat generally located in the legs. For various reasons, many consumers tend to prefer white poultry meat over dark meat. One reason for this preference has been the greater difficulty in processing dark meat to provide boneless meat products, due to the centralized locations of leg bones. Poultry thighs, for example, are typically sold with the skin in place and the thigh meat surrounding an elongated bone extending along the middle of the thigh from one end to the other. Another reason consumers tend to prefer white meat is that the texture of dark meat, which typically has more fat and connective tissue, is considered less appealing than the more consistent texture of white meat. Moreover, dark meat typically has a higher fat content in comparison to white meat.

### SUMMARY OF THE INVENTION

There remains a need for boneless thigh products that have an appealing texture and a lower fat content similar to that of white meat. Accordingly, an embodiment of the present invention provides a method for preparing a boneless thigh meat poultry product from a poultry thigh, the method comprising the steps of: making one or more cuts of the meat at the inner side of the thigh substantially along the longitudinal axis of the bone, wherein the one or more cuts cause a first edge of the meat and a second edge of the meat to separate from each other; making one or more additional cuts of the meat to detach the bone from the meat; spreading the first edge and the second edge apart from one another in a substantially lateral direction away from the longitudinal axis of the bone; making one or more cuts of the meat at the outer side of the thigh along a first interface between a center portion and a left portion sufficient to separate the center portion from the left portion; and making one or more cuts of the meat at the outer side of the thigh along a second interface between the center portion and a right portion sufficient to separate the center portion from the right portion.

Another embodiment of the present invention provides a boneless thigh meat poultry product consisting of the premium thigh cut made according to methods described herein. The boneless thigh meat poultry product preferably has a fat content of less than about 2%, and is substantially free of fat, cartilage, and sinew. Another embodiment of the present invention provides a package containing the premium thigh cut. The package may further contain a marinade or sauce.

### BRIEF DESCRIPTION OF THE DRAWINGS

The invention may be further understood by reference to the drawings in which:

FIG. 1 depicts a top view of the outer side of a skinless chicken thigh;

FIG. 2 depicts a top view of the inner side of the skinless chicken thigh shown in FIG. 1;

FIG. 3 depicts a top view of the inner side of the chicken thigh shown in FIG. 2 after one or more cuts have been made in order to remove the bone, and before the bone has been removed from the thigh, according to an embodiment of the present invention;

FIG. 4 depicts a top view of the outer side of the chicken thigh shown in FIG. 3 after the bone has been removed from the thigh and the edges of the thigh separated by the cut along the bone have been spread apart from one another, according to an embodiment of the present invention;

FIG. 5 depicts a top view of the inner side of the chicken thigh shown in FIG. 3 after the bone has been removed from the thigh, according to an embodiment of the present invention;

FIG. 6 depicts a top view of the outer side of the chicken thigh after the center portion 7 has been separated from the left portion 8 and right portion 9, according to an embodiment of the present invention; and

FIG. 7 depicts a top view of the inner side of the chicken thigh after the center portion 7 has been separated from the left portion 8 and right portion 9, according to an embodiment of the present invention.

### DETAILED DESCRIPTION OF THE INVENTION

The present invention provides methods for processing poultry thigh meat (e.g., thigh meat of chicken or turkey). The applicant has discovered methods for isolating a portion of thigh meat (a “premium thigh cut”) that cooks more evenly than the thigh generally and has an appealing texture. The methods provide boneless thigh products that have a low fat content, and are substantially free of undesirable components such as sinew and cartilage.

Other methods for processing poultry thigh meat have been described, for example, in U.S. Pat. No. 7,008,313. According to the '313 patent, after the bone has been removed from the thigh, the “thin muscle” of the thigh is removed from the “thick muscle” by cutting entirely through the meat along the path of the removed bone. Next, the “red muscle” of the thigh is removed from the thick muscle by making a second cut which is parallel to the top surface of the thick muscle. Additional cuts are made in order to provide equally sized strips of the thick muscle. Among other differences between the present invention and the '313 patent, and as set forth in more detail below, the methods of the present invention do not include a step of cutting entirely through the meat along the path of the removed thigh bone, as this would cause the “premium thigh cut” to be severed into two pieces.

The method steps described herein that comprise cutting poultry thigh meat may be made by hand or by machine, using a knife (e.g., a wizard knife), saw, or any other suitable cutting instrument or device known to those skilled in the art.

According to one embodiment of the present invention, the method comprises removing the skin (e.g., all of the skin, or substantially all of the skin) from a poultry thigh, preferably before making any cuts in the thigh meat. The skin may be removed from the thigh according to any method known to those skilled in the art.

The skinless poultry thighs depicted in the figures have two opposing sides, namely, an outer side and an inner side. Although the presently described embodiments and figures employ a chicken thigh for illustrating the present invention, the invention is equally applicable to any other poultry (i.e., fowl, birds, and the like). FIG. 1 is a top view of the outer side 2 of a chicken thigh 1 from which the skin has been removed. The smooth portion 4 of the outer thigh in FIG. 1 that is depicted as having curved lines is substantially free of any fat, cartilage, or sinew, and has an outer surface with a smooth and substantially consistent texture. Several of the outer portions of the outer thigh, which surround the smooth portion 4 as seen from the top view, and which do not have curved lines, are portions which contain components such as fat, cartilage, or sinew, and which generally do not have a smooth, consistent texture. FIG. 2 is a top view of the inner side 3 of the chicken thigh shown in FIG. 1. Several portions of the inner side 3 of the thigh, which do not have curved lines, contain fat, cartilage, or sinew. These portions generally do not have a smooth, consistent texture. The ends 5a, 5b of the thigh bone 5 can be seen protruding from the thigh.

According to one aspect of the present invention, a method for preparing a boneless thigh meat poultry product from a poultry thigh comprises removing the bone 5 from the thigh 1. The one or more cuts made in the thigh to detach the bone from the thigh meat can be made using a knife (e.g., a wizard knife, such as a circular wizard knife), saw, or any other suitable cutting instrument or device known to those skilled in the art. According to particular embodiments, removing the bone 5 from the thigh 1 comprises making one or more cuts of the meat at the inner side of the thigh substantially along the longitudinal axis 6 of the bone (depicted as a dashed line in FIG. 2). One or more of the cuts are preferably made from one end of the bone (5a or 5b) to the other end of the bone (5a or 5b). Stated another way, removing the bone 5 from the thigh 1 comprises making one or more cuts in the thigh meat that overlays the bone 5 on the inner side 3 of the thigh (i.e., the thigh meat that covers the bone as viewed from the top view of the inner side 3 of the thigh, as shown in FIG. 2) in a longitudinal direction with respect to the bone 5 (i.e., lengthwise along the bone), preferably from one end of the bone (5a or 5b) to the other end of the bone (5a or 5b). According to some embodiments, the one or more cuts along the longitudinal axis 6 may extend past the ends of the bone 5a, 5b; for example, from the top to the bottom of the meat substrate as shown in the top view of FIG. 2, or only part of the way from the ends of the bone to the top or bottom of the meat substrate. Making the one or more cuts along the longitudinal axis 6 of the bone causes a first edge of the meat and a second edge of the meat to separate from each other (e.g., with the first edge located immediately to the left of the cut and the second edge located immediately to the right of the cut).

FIG. 3 is a top view of the inner side 3 of the chicken thigh shown in FIG. 2 after one or more cuts have been made in order to detach the bone 5 from the surrounding thigh meat. According to a particular embodiment, after the one or more cuts have been made along the longitudinal axis of the bone 6, as described above, removing the bone 5 from the thigh 1 further comprises making one or more additional cuts in the meat of the inner side of the thigh sufficient to detach the bone from the meat, i.e., the one or more additional cuts cause the bone to detach from the meat. These one or more additional cuts may comprise, for example, cutting next to the bone, along each side of the bone 5 in a direction substantially parallel to the longitudinal axis of the bone 6 (e.g., longitudinally along the left side of the bone 5c and/or longitudinally along the right side of the bone 5d). Such one or more additional cuts may further comprise cuts underneath the bone (as shown in FIG. 3), in order to separate all of the meat from the bone in order to easily detach the bone from the meat. One or more of the additional cuts are preferably made along the length of the bone from one end (5a or 5b) to the other (5a or 5b).

According to preferred embodiments, the step(s) of removing the bone from the thigh, as described herein, comprise using a knife, most preferably a wizard knife (e.g., a circular wizard knife). It should be understood that the cuts described above for removing the bone from the inner side of the thigh meat do not penetrate all the way through the thigh meat, i.e., the surface of the outer side 2 of the thigh meat is not punctured when the one or more cuts are made on the inner side 3, but remains intact. As illustrated in FIG. 3, the one or more cuts help expose the bone, as seen from the top view, so that the bone can be removed from the inner side of the thigh. According to alternative embodiments, the method may further comprise making one or more additional cuts to remove any excess fat, skin, vein assemblies and/or dangling muscles.

According to one embodiment, the method comprises using a knife (preferably a circular wizard knife) to detach the bone from the meat by making three cuts. Specifically, this embodiment comprises making a first cut substantially along the longitudinal axis 6 of the bone, wherein the knife is angled underneath the meat in a first direction, toward either the right or left of the longitudinal axis 6 (in order to detach the meat overlaying the bone on the right or left side of the longitudinal axis); making a second cut substantially along the longitudinal axis 6 of the bone, wherein the knife is angled underneath the meat in the other direction toward the right or left of the longitudinal axis 6 (in order to detach the meat overlaying the bone on the right or left side of the longitudinal axis); and making a third cut underneath the bone (to detach the meat from underneath the bone).

As described above, making the one or more cuts along the longitudinal axis 6 of the bone causes a first edge of the meat to separate from a second edge of the meat. According to another aspect of the present invention, the method further comprises spreading the first edge and the second edge apart from one another in a substantially lateral direction away from the longitudinal axis 6 of the bone (e.g., in the directions illustrated by arrows 6a and 6b in FIG. 2). Stated another way, an embodiment of the method comprises folding the meat away from the longitudinal axis 6 of the bone (e.g., to the right and to the left of the longitudinal axis 6, in a direction away from the longitudinal axis 6 as viewed from a top view of the inner side of the thigh). FIG. 3 shows the inner side 3 of a chicken thigh after at least some of the meat has been folded away from the longitudinal axis of the bone 6. According to preferred embodiments, the thigh meat is substantially “flattened out” by spreading or folding the edges of the meat away from the longitudinal axis of the bone 6. The thigh meat may be substantially flattened out by hand, preferably without tearing or stretching the meat.

According to a particular embodiment, the method comprises removing the bone from the thigh and subsequently flattening the thigh meat as described above. Alternatively, the method may comprise spreading the first edge and the second edge apart from one another after making the one or more cuts along the longitudinal axis 6 of the bone, subsequently making one or more of the additional cuts to detach the bone (which create additional “edges” in the meat), and subsequently spreading or folding these additional edges away from the longitudinal axis of the bone 6. It should be noted that spreading or folding edges of the meat away from each other to substantially flatten out the thigh meat may be performed before and/or after the bone has been fully detached or removed from the thigh meat (references made herein to the longitudinal axis 6 of the bone, e.g., to spreading the meat away from the longitudinal axis 6, does not necessarily mean the bone is still attached or in contact with the thigh meat).

FIG. 4 is a top view of the outer side 2 of the chicken thigh shown in FIG. 3 after the bone has been removed from the thigh. FIG. 5 is a top view of the inner side 3 of the chicken thigh shown in FIG. 3 after the bone has been removed from the thigh. As illustrated in FIG. 4, after the bone has been removed, the thigh comprises a center portion 7 and two outer portions (a left portion 8 and a right portion 9, as viewed from a top view of the outer side of the chicken thigh). In the embodiment shown in FIG. 4, the center portion is generally located between lines 10 and 11, with the left portion 8 generally located to the left of line 10 and the right portion 9 generally located to the right of line 11. The smooth portions 4 of the center portion 7 shown in FIG. 4 that are depicted as having curved lines are substantially free of any fat, cartilage, or sinew, and have an outer surface with a smooth, substantially consistent texture.

As shown in FIG. 4, the center portion 7 is substantially free of any fat, cartilage, or sinew, and has an outer surface with a smooth, substantially consistent texture, whereas the left and right portions have greater amounts of fat, cartilage, or sinew compared to the center portion 7, and generally do not have a smooth, consistent texture. Moreover, in an embodiment, the center portion 7 has a significant proportion of substantially uniformly aligned muscle fibers throughout the substrate of that portion, as illustrated by the curved lines in FIG. 4. It should be noted that uniformly aligned muscle fibers does not mean that the fibers extend linearly; as is well-known, such fibers typically have a natural curvature. Instead, the phrase “substantially uniformly aligned muscle fibers” means that at any point, adjacent fibers are parallel or substantially parallel if they are linear or have tangents that are parallel or substantially parallel if they are curved. The proportion of substantially uniformly aligned muscle fibers in the center portion 7 in this embodiment is significant. This may be contrasted with the left portion 8 and right portion 9. Those portions consist of multiple “sections,” each section having muscle fibers extending in pathways unique to that section, and in pathways that are different from each other. Stated another way, the center portion 7 is preferably made entirely, or almost entirely, of a single section having substantially uniformly aligned muscle fibers extending in a first pathway, whereas the left portion 8 and right portion 9 are each made of multiple sections, with each of the sections having substantially uniformly aligned muscle fibers extending in a pathway different from the other sections within the same portion (left 8 or right 9). Preferably, the proportion of substantially uniformly aligned muscle fibers in the center portion 7 is greater than (i) the proportion of substantially uniformly aligned muscle fibers in the entire thigh, and/or (ii) the proportion of substantially uniformly aligned muscle fibers in the left portion 8 alone, and/or (iii) the proportion of substantially uniformly aligned muscle fibers in the right portion 9 alone.

According to a preferred embodiment, the center portion is substantially free of fat, cartilage, and sinew. As used herein, the term “center portion” 7 is interchangeable with the term “premium thigh cut.”

In particular embodiments, both the left portion 8 and right portion 9 comprise a larger proportion of fat, cartilage, and/or sinew in comparison to the center portion 7.

As illustrated in FIG. 4, the center portion 7 is separated from the left portion 8 and right portion 9 by interfaces which are substantially parallel to the longitudinal axis of the bone. Each interface is typically visible as a separating portion 12, 13. Each separating portion 12, 13 typically comprises a crease in the outer side of the meat and/or a segment of fat, cartilage, or sinew that runs along the entire length, or a substantial length, of the left and right sides of the center portion 7. The dashed lines 10 and 11 shown in FIG. 4 illustrate the locations of the interfaces.

According to another aspect of the present invention, the method comprises separating the center portion 7 from the left portion 8 and right portion 9. Separating the center portion from the left and right portions preferably comprises making one or more cuts in the meat of the outer side of the thigh along an interface 12 between the center portion 7 and the left portion 8 (e.g., substantially along line 10) sufficient to separate the center portion 7 from the left portion 8 (i.e., the one or more cuts cause the center portion and the left portion to separate from each other); and making one or more cuts in the meat of the outer side of the thigh along an interface between the center portion 7 and the right portion 9 (e.g., substantially along line 11) sufficient to separate the center portion 7 from the right portion 9 (i.e., the one or more cuts cause the center portion and the left portion to separate from each other). Thus, after one or more cuts in each interface 12, 13 have been made, the entire center portion 7 (including the inner side and outer side) is completely detached from the left portion 8 and right portion 9. One or more of the cuts that are made to separate the center portion from each of the left and right portions are made all the way through the thigh meat (i.e., through the outer side and inner side). According to alternative embodiments, the method may further comprise removing a vein assembly on the inner side of the center portion, if it has remained intact after separating the center portion from the right and left portions.

FIG. 6 depicts a top view of the outer side 2 of the thigh after the center portion 7 has been separated from the left portion 8 and right portion 9; and FIG. 7 depicts a top view of the inner side 3 of the thigh after the center portion 7 has been separated from the left portion 8 and right portion 9.

According to an embodiment of the present invention, a boneless thigh meat poultry product consists of the center portion 7 or “premium thigh cut” made according to the methods described herein. The center portion 7, which has been separated from the poultry thigh according to embodiments of the methods described herein, is a boneless thigh meat poultry product that is substantially free of undesirable components such as fat, cartilage, and sinew. As a result, the center portion 7 cooks generally evenly and has an appealing texture and “mouth feel.” Moreover, the center portion has a low fat content, which is preferably less than about 2%, or between about 1% to about 2%, and which is comparable to the fat content of many boneless, skinless chicken breasts currently on the market. According to particular embodiments, the center portion or “premium thigh cut” makes up between about 20 wt % to about 60 wt % of the total thigh, more preferably about 30 wt % to about 50 wt % of the total thigh, more preferably about 30 wt % to about 50 wt % of the total thigh, and most preferably about 40 wt % to about 45 wt % of the total thigh.

The center portion 7 is a significantly different food product in comparison to the food products achieved by the methods of U.S. Pat. No. 7,008,313. As discussed above, after the bone has been removed from the thigh, the '313 patent describes removing the “thin muscle” of the thigh from the “thick muscle” by cutting along the path of the removed bone. The methods of the present invention do not include a step of cutting along the path of the removed bone through the entire meat substrate, as this would cause the center portion 7 to be severed into two pieces. As illustrated in FIGS. 3 and 4, for example, the path of the removed bone essentially runs through the middle of the center portion 7.

Another embodiment of the present invention provides a package (e.g., a container suitable for storing a food product) which contains the boneless thigh meat poultry product described above (i.e., the center portion 7), or a plurality of such portions, and/or such portion(s) cut into strips or cubes, and/or such portion(s) in the form of pulled meat. According to particular embodiments, the package further comprises a marinade (e.g., a sauce, dressing, or seasoned liquid), in addition to the boneless thigh meat poultry product, either as a single whole portion, multiple portions, or cut into strips or cubed, or as pulled meat. The marinade, which may contain oils, herbs, and/or spices to further flavor and/or tenderize the poultry product, enables the consumer to skip the step of marinating the poultry product after removing it from the package, as the poultry product has already been marinated inside the package. According to another embodiment, a package comprises a breaded poultry product comprising the boneless thigh meat poultry product described herein substantially coated with breading, or multiple such breaded portions in a single package, or breaded strips or cubes of such a portion in a single package.

Another embodiment of the present invention provides an assembly comprising a package (e.g., a container suitable for storing a food product) and at least one boneless thigh meat poultry product (i.e., at least one premium thigh cut, preferably from chicken) enclosed within the package. The boneless thigh meat poultry product(s) preferably have a fat content of less than about 2% (e.g., between about 1% to about 2%). The assembly may comprise a plurality of such boneless thigh meat poultry products, and/or such product(s) cut into strips or cubes, and/or such product(s) in the form of pulled meat, enclosed within the package. According to particular embodiments, the assembly further comprises a marinade enclosed within the package (e.g., a sauce, dressing, or seasoned liquid) which may contain oils, herbs, and/or spices to further flavor and/or tenderize the poultry product, in addition to the boneless thigh meat poultry product, either as a single whole portion, multiple portions, or cut into strips or cubed, or as pulled meat. According to another embodiment, the boneless thigh meat poultry product(s) are substantially coated with breading. The assembly may further comprise one or more food products enclosed within the package, in addition to the boneless thigh meat poultry product(s) (e.g., one or more additional portions of poultry meat which may or may not comprise thigh meat, such as one or more portions of breast meat).

Although the present invention has been described in connection with specific embodiments, it should be understood that the invention as claimed should not be unduly limited to such specific embodiments. Indeed, various modifications and variations of the described compositions and methods of the invention will be apparent to those of ordinary skill in the art and are intended to be within the scope of the appended claims.

What is claimed is:

1. A method for preparing a boneless thigh meat poultry product from a poultry thigh, the method comprising the steps of:
making one or more cuts of the meat at the inner side of the thigh substantially along the longitudinal axis of the bone, wherein the one or more cuts cause a first edge of the meat and a second edge of the meat to separate from each other;
making one or more additional cuts of the meat, wherein the one or more additional cuts cause the bone to detach from the meat;
spreading the first edge and the second edge apart from one another in a substantially lateral direction away from the longitudinal axis of the bone;
making one or more cuts of the meat at the outer side of the thigh along a first interface between a center portion and a left portion sufficient to separate the center portion from the left portion; and
making one or more cuts of the meat at the outer side of the thigh along a second interface between the center portion and a right portion sufficient to separate the center portion from the right portion.

2. The method according to claim 1 comprising using a knife to make one or more of the cuts.

3. The method according to claim 1 further comprising removing the skin from the thigh prior to making any cuts in the meat.

4. The method according to claim 1, wherein the step of making one or more cuts of the meat at the inner side of the thigh substantially along the longitudinal axis of the bone comprises making one or more of the cuts from one end of the bone to the other end of the bone.

5. The method according to claim 1, wherein the step of making one or more additional cuts of the meat at the inner side of the thigh comprises cutting along each side of the bone in a direction substantially parallel to the longitudinal axis of the bone.

6. The method according to claim 1 further comprising spreading additional edges of the meat, created by the one or more additional cuts, away from the longitudinal axis of the bone.

7. The method according to claim 1, wherein the center portion is substantially free of any fat, cartilage, or sinew.

8. The method according to claim 1, wherein the center portion comprises a smaller proportion of fat, cartilage, and sinew in comparison to the left portion and right portion.

9. A boneless thigh meat poultry product consisting essentially of the center portion made according to the method of claim 1.

10. The boneless thigh meat poultry product according to claim 9, wherein the poultry product has a fat content of less than about 2%.

11. The boneless thigh meat poultry product according to claim 9, wherein the poultry product has a fat content between about 1% to about 2%.

12. A package containing at least one boneless thigh meat poultry product according to claim 9.

13. The package according to claim 12, wherein the package further comprises a marinade.

14. A breaded poultry product comprising the boneless thigh meat poultry product according to claim 9 substantially coated with breading.

15. The method according to claim 1, wherein the thigh is the thigh of a chicken.

16. An assembly comprising:
a package; and
at least one boneless thigh meat poultry product having a fat content of less than about 2% enclosed within the package.

17. The assembly according to claim 16, wherein the at least one boneless thigh meat poultry product has a fat content between about 1% to about 2%.

18. The assembly according to claim 16, wherein the at least one boneless thigh meat poultry product is substantially coated with breading.

19. The assembly according to claim 16 further comprising a marinade enclosed within the package.

20. The assembly according to claim 16 comprising a plurality of the boneless thigh meat poultry products enclosed within the package.

21. The food product package according to claim 16, wherein the at least one boneless thigh meat poultry product comprises chicken thigh meat.

22. The food product package according to claim 16 further comprising one or more food products, in addition to the at least one boneless thigh meat poultry product, enclosed within the package.

23. The food product package according to claim 22, wherein the one or more food products comprise one or more additional portions of poultry meat.
